(19) United States
(12) Patent Application Publication
(10) Pub. No.: US 2025/0043034 A1
(43) Pub. Date: Feb. 6, 2025

(54) Processes for Making Polyolefins with Composition Control

(71) Applicant: ExxonMobil Technology and Engineering Company, Baytown, TX (US)

(72) Inventors: Giriprasath Gururajan, Missouri City, TX (US); Rong Ma, Houston, TX (US); Narayanaswami Dharmarajan, Houston, TX (US); Jean-Roch Schauder, wavre (BE)

(21) Appl. No.: 18/717,173

(22) PCT Filed: Dec. 14, 2022
(86) PCT No.: PCT/US2022/081511

§ 371 Date: Jun. 6, 2024

Related U.S. Application Data
(60) Provisional application No. 63/290,997, filed on Dec. 17, 2021.

(51) Int. Cl. C08F 2/01; C08F 4/659

(52) U.S. Cl. CPC C08F 2/01; C08F 4/659; C08F 2420/02; C08F 2500/06; C08F 2500/08; C08F 2500/09; C08F 2500/12; C08F 2500/27

(57) ABSTRACT

Processes for making olefin copolymers, particularly ethylene-based copolymers. A process for making an olefin copolymer can include introducing an olefin monomer, at least one other olefin comonomer, and a single type of catalyst system to a tubular reactor to produce an olefin copolymer containing: a) an absolute comonomer distribution (CD) slope 90 of about 2.0 to about 30.0, an absolute CD slope 75 of about 2.0 to about 30.0, an absolute CD slope 50 of about 2.0 to about 30.0, or an absolute CD slope 25 of about 2.0 to about 30.0; b) a first long chain branching index (g′(Mz)) of about 0.30 to about 1.0; and c) a second long chain branching index (g′(Mz+1)) of about 0.30 to about 1.0. The tubular reactor can include one or more plug flow components, one or more spiral heat exchangers, and/or a recycle pump.

### CROSS-REFERENCE TO RELATED APPLICATIONS

This application claims the benefit of U.S. Provisional Application No. 63/290,997, filed on Dec. 17, 2021, the entire contents of which are incorporated herein by reference.

### FIELD

Embodiments of the present invention generally relate to processes for making polyolefins and polyolefins made by same. More particularly, such embodiments relate to processes for making olefin copolymers, such as ethylene-based copolymers, while controlling the compositions of those copolymers using a single type of catalyst system and a single tubular reactor.

### BACKGROUND

Polyolefin homopolymers, copolymers, terpolymers, etc., can be produced using various types of catalyst systems and polymerization processes. One type of catalyst system that can be used to produce polyolefins is a metallocene-based catalyst system. Metallocene catalysts are homogenous single site catalysts that include organometallic coordination compounds in which one or two cyclopentadienyl rings or substituted cyclopentadienyl rings are π-bonded to a central transition metal atom. Catalyst systems including single site catalysts typically produce polyolefins with a narrow molecular weight distribution and a uniform distribution of comonomer among the molecules as opposed to a broad molecular weight distribution and a broad comonomer distribution among the chains, e.g., a higher molecular weight chain with lower comonomer insertion and a lower molecular weight chain with higher comonomer insertion.

While a polymer having a narrow molecular weight distribution and a uniform comonomer distribution along the polymer chain can be advantageous for certain processes and end-use applications, this type of polymer can be undesirable for others. For example, a narrow molecular weight distribution polymer may require the use of a fluoropolymer additive in order to process the polymer at desirable production rates without flow instabilities, such as melt fracture. Unfortunately, the use of a fluoropolymer processing aid increases the cost of producing a finished article from the polymer. Stability in other polymer processing operations, such as blown film and blow molding, often is reduced with a narrow molecular weight distribution polymer, as compared to a broader molecular weight distribution polymer, resulting in reduced production rates. Also, a polymer having a uniform comonomer distribution as compared to a polymer having a broad comonomer distribution among different chains (also referred to a conventional composition distribution) can have less desirable melt processability. Having the ability to control the molecular weight distributions and the comonomer distributions of polymers produced using a single-site catalyst is therefore highly desirable.

Catalyst systems including single-site catalysts can be used to produce polyolefins having moderate amounts of long chain branched molecules. In some instances, long chain branching is desired to enhance the processibility of the resulting polymer. For example, the presence of long chain branching can improve bubble stability during film blowing. However, for many end use applications, significant amounts of long chain branching can undesirably produce a polymer with effects on tear and tensile properties. Therefore, having the ability to control the amount of long chain branching in polymers using catalyst systems including single-site catalysts is a desirable goal.

Other catalysts, such as chromium or Ziegler-Natta (ZN) type catalysts, can be used to produce broader molecular weight distribution polymers. However, when either a chromium or a ZN catalyst is employed, the use of hydrogen in the olefin polymerization process can cause a narrowing of the molecular weight distribution and lowering molecular weights of the resulting polymer. Another drawback of the use of a ZN catalyst is that the resulting polymer tends to have low molecular weight ends that are detrimental to the mechanical properties of the polymer. To overcome the challenges involved in using chromium or ZN catalysts, mixed metallocene-based catalyst systems containing multiple metallocene catalysts have been developed that can be used to control the molecular weight distribution of the polymer. Ways have also been developed to control the molecular weight distribution using two or more reactors with a metallocene-based catalyst system. However, both of these options are very expensive and are not generally performed using a solution polymerization process. Also, these options do not provide for efficient control of molecular weight distribution, comonomer distribution, and long chain branching all at the same time.

A need therefore exists for a way to inexpensively produce polyolefins using a catalyst system including a single-site catalyst and a solution polymerization process while at the same time being able to control the molecular weight, comonomer distribution, and long chain branching of the resulting polymer. Also, it would be beneficial to have the ability to produce, in the presence of hydrogen, a polymer having a broad molecular weight distribution and a broad comonomer distribution using a single site catalyst.

### SUMMARY

Processes for making olefin copolymers, particularly ethylene-based copolymers, are provided. In one or more embodiments, a process for making an olefin copolymer can include introducing an olefin monomer, at least one other olefin comonomer, and a single type of single site catalyst to a tubular reactor to produce an olefin copolymer containing: a) an absolute comonomer distribution (CD) slope 90 of about 2.0 to about 30.0, an absolute CD slope 75 of about 2.0 to about 30.0, an absolute CD slope 50 of about 2.0 to about 30.0, or an absolute CD slope 25 of about 2.0 to about 30.0; b) a first long chain branching index (g′(Mz)) of about 0.30 to about 1.0; and c) a second long chain branching index (g′(Mz+1)) of about 0.30 to about 1.0. The tubular reactor can include one or more plug flow elements, one or more heat exchangers, and at least one recycle pump.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1a depicts a tubular reactor containing a spiral heat exchanger oriented in a substantially vertical direction, according to one or more embodiments provided herein.

FIG. 1b depicts a top view of the spiral heat exchanger in FIG. 1a.

FIG. 2 depicts a tubular reactor containing a spiral heat exchanger oriented in a substantially horizontal direction, according to one or more embodiments provided herein.

FIG. 3a is a graph depicting the molecular weight distribution and the comonomer distribution along the polymer chain for ethylene-octene copolymers, according to one or more embodiments provided herein.

FIG. 3b is a graph depicting slopes of the comonomer distribution profiles in FIG. 3a, according to one or more embodiments provided herein.

FIG. 4 is a graph depicting TREF distribution profiles for the aforementioned ethylene-octene copolymers, according to one or more embodiments provided herein.

FIG. 5a is a graph depicting slopes of the comonomer distribution profiles of additional ethylene-octene copolymers, according to one or more embodiments provided herein.

FIG. 5b is a graph depicting TREF distribution profiles for the additional ethylene-octene copolymers, according to one or more embodiments provided herein.

FIG. 6 is a Van Gurp-Palmen plot depicting the complex modulus versus phase angle for the additional ethylene-octene copolymers, according to one or more embodiments provided herein.

FIG. 7 is a graph depicting the observed Mw versus the predicted Mw for ethylene-octene copolymers, according to one or more embodiments provided herein.

FIG. 8a is a graph depicting the observed and predicted comonomer distribution slope 90 versus octene concentration for ethylene-octene copolymer production, according to one or more embodiments provided herein.

FIG. 8b is a graph depicting the observed and predicted comonomer distribution slope 75 versus cement concentration for ethylene-octene copolymer production, according to one or more embodiments provided herein.

FIG. 9 is a graph depicting long chain branching index (g′(Mz)) versus ethylene concentration for ethylene-octene copolymer production, according to one or more embodiments provided herein.

FIG. 10 is a graph depicting the molecular weight distribution and the comonomer distribution along the polymer chain for ethylene-butene copolymers, according to one or more embodiments provided herein.

FIG. 11 is a graph depicting average slopes of comonomer distribution profiles versus Mz/Mw values for ethylene-octene copolymers and ethylene-butene copolymers, according to one or more embodiments provided herein.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

The term “polymer” refers to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “continuous” refers to a system that operates without interruption or cessation. For example, a continuous process to produce a polymer would be one where the reactants are continually introduced into one or more reactors and polymer product is continually withdrawn.

The term “solution polymerization” refers to a polymerization process in which the polymer is dissolved in a liquid polymerization medium, such as an inert solvent, monomer(s), or blends thereof. A solution polymerization is typically homogeneous. The term “homogeneous polymerization” refers to a polymerization process where the polymer product is dissolved in the polymerization medium. Such systems are preferably not turbid as described in J. Vladimir Oliveira, C. Dariva, and J. C. Pinto, Ind. Eng. Chem. Res., 29, 2000, 4627. A homogeneous polymerization process is typically a process where at least 90 wt % of the product is soluble in the reaction media.

The term “laminar” flow refers to flow of a fluid (e.g., gas, liquid) in parallel layers without disruption between the layers. Fluids may exhibit laminar flow near a solid boundary. “Near-laminar” flow refers to flow of a fluid in parallel layers with minimal disruption between the layers.

As used herein, “Mn” refers to the number average molecular weight of the different polymers in a polymeric material, “Mw” refers to the weight average molecular weight of the different polymers in a polymeric material, and “Mz” refers to the z average molecular weight of the different polymers in a polymeric material. The terms “molecular weight distribution” (MWD) and “polydispersity index” (PDI) are used interchangeably to refer to the ratio of Mw to Mn. Unless otherwise noted, all molecular weights (e.g., Mw, Mn, Mz) are reported in units of g/mol.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

A detailed description will now be provided. Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

Processes for making olefin copolymers are disclosed herein that can include introducing an olefin monomer, at least one other olefin comonomer, and a single type of catalyst system to a single tubular reactor to produce olefin copolymer. The term “tubular reactor” refers to a reactor into which feed is continuously introduced (e.g. via an inlet) and from which product is continuously removed (e.g., via an outlet), wherein stirring typically does not occur within the reactor. For example, the tubular reactor can be substantially tubular shaped, and can include a straight pipe or a loop to enable recycle. The tubular reactor may include one or more plug flow components and/or one or more lamellar flow elements. The tubular reactor can include a recycle pump. Preferably, the tubular reactor can include one or more heat exchangers. The heat exchanger(s) can be a spiral heat exchanger (SHE). Surprisingly, olefin copolymers having a nonuniform, broad comonomer distribution along the chain of the polymer and a broad molecular weight distribution (MWD) as determined by Gel Permeation Chromatography (GPC) can be produced using only a single tubular reactor having with a single type of catalyst system including a single site catalyst even in the presence of hydrogen. As described previously, olefin copolymers having these properties usually cannot be produced using only one catalyst system and one tubular reactor. Also, such copolymers usually cannot be produced using a continuous stirred-tank reactor (CSTR). Thus, the processes disclosed herein are not only simpler than other processes used to produce olefin copolymers having such properties but also more cost effective.

The absolute comonomer distribution (CD) slope 25, slope 50, slope 75, and slope 90 of the olefin copolymers produced herein unexpectedly can range from 2.0 to 30.0, which indicates that the copolymers can have a broad comonomer distribution. One or two or all of the absolute slopes can be greater than 2. The absolute slopes can increase in ascending order from slope 25 up to slope 90, they can increase in descending order from slope 90 down to slope 25, or they can increase in random order. A polymer having a broad comonomer distribution has either a relatively high molecular weight chain with lower comonomer incorporation or a relatively low molecular weight chain with higher comonomer incorporation. In a preferred embodiment, the absolute CD slope 75 of the olefin copolymers ranges from 2.0 to 20.0. In a preferred embodiment, the absolute CD slope 90 of the olefin copolymers ranges from 2.0 to about 20.0. The averages of the absolute slopes, i.e., (slope 50+slope 75)/2, (slope 25+slope 50)/2, and (slope 75+slope 90)/2, of the olefin copolymers can have values up to 15.0, preferably from 0.1 to 12.0, or more preferably from 0.1 to 10.0 for all Mz/Mw values in the range of 1.5 to 6.0. In a preferred embodiment, the olefin copolymers have absolute slope averages in the range of 1.5 to 12.0 for all Mz/Mw values in the range of 1.8 to 6.0.

The copolymers produced herein can also have a MWD (Mw/Mn) ranging from 2.0 to 7.0, indicating that the MWD of the copolymers can be broad. In a preferred embodiment, the MWD of the olefin copolymers ranges from 2.0 to about 6.0. The copolymers can have a Mz/Mw value ranging from 1.5 to 6.0, preferably from 1.8 to 6.0, or more preferably from 1.8 to 5.0. The copolymers can also have a Mz/Mn value ranging from 3.0 to 40.0, preferably from 3.0 to 30.0, or more preferably from 3.0 to 25.0. The procedures that can be used to determine CD slopes and molecular weight moments and distributions are described in the Examples below.

Advantageously, the polyolefin copolymers produced herein can also exhibit low levels of long chain branching (LCB). In particular, the copolymers can have a first long chain branching index (g′(Mz)) ranging from 0.30 to 1.00, preferably from 0.70 to 0.97. The copolymers can have a second long chain branching index (g′(Mz+1)) of from 0.30 to 1.00, preferably from 0.70 to 0.97. A description of the methods used to determine the LCB indices can be found in the Examples below.

The olefin copolymers produced herein can have a density of from 0.850 g/cc to 0.920 g/cc, as measured according to ASTM D792, which indicates that they can serve as plastomers having the combined qualities of elastomers and polymers. The olefin copolymers also can have broad melt index (MI) values ranging from 0.1 dg/min to 500.0 dg/min and melt index ratios (MIRs) (MI_{21.6}/MI_{2.16}) ranging from 20.0 to about 100.0, both of which are measured according to ASTM D1238 (190° C./2.16 kg).

Another advantage of the processes disclosed herein is that the weight average molecular weight (Mw) and hence the MWD, the comonomer distribution, and the level of long chain branching for the copolymers produced herein can all be controlled using the exemplary equations provided below. The Mw can be calculated using the following equation:

$${( Mw )}^{2.2} - 2.1E+011 + 1.5E+9 * T avg - \text{} 2.7E+8 * H 2 / C 2 + 4.1E+10 * C 2 conc + 3.4E+011 * C 8 conc - 1.8E+9 * T avg * C 8 conc - 1.9E+010 * C 2 conc * C 8 conc$$

where T avg is the average of reactor inlet and outlet temperatures in ° C., H2/C2 is the molar ratio of the hydrogen to the ethylene introduced to the reactor, C2 conc is the ethylene concentration in wt %, and C8 conc is the at least one other comonomer concentration (e.g., octene concentration) in wt %, with all weight percentages being based on the total weight of the solution being introduced to the reactor. The Mw in g/mol units can be controlled based on the calculated Mw.

The CD slope 90 can be calculated using the following equation:

$$Sqrt ( Slope 90 ) = + 0 \text{.11} - 7.6E-003 * H 2 / C 2 + 0.5 * C 2 conc - 0.2 * C 8 conc + 0.2 * Cement conc$$

where H2/C2 is the molar ratio of the hydrogen to the ethylene introduced to the reactor, C2 conc is the ethylene concentration in wt %, C8 conc is the at least one other comonomer concentration (e.g., octene concentration) in wt %, and Cement conc is the cement concentration in wt %, with all weight percentages being based on the total weight of the solution being introduced to the reactor. The comonomer distribution can be controlled based on the calculated CD slope 90.

The CD slope 75 can be calculated using the following equation:

$$Sqrt ( Slope 75 ) = + 2.6 - 0.011 ⋆ T avg - 5.7E-003 ⋆ H 2 / C 2 + 0.13 ⋆ C 2 conc - 0.06 ⋆ C 8 conc + 0.1 ⋆ Cement conc$$

where T avg is the average of reactor inlet and outlet temperatures in ° C., H2/C2 is the molar ratio of the hydrogen to the ethylene introduced to the reactor, C2 conc is the ethylene concentration in wt %, C8 conc is the at least one other comonomer concentration (e.g., octene concentration) in wt %, and Cement conc is the cement concentration in wt %, with all weight percentages being based on the total weight of the solution being introduced to the reactor. The comonomer distribution also can be controlled based on the calculated CD slope 75.

The long chain branching index g′(Mz) can be calculated using the following equation:

$${g}^{′} - Mz = + 0.89 + 1.47E-004 * H 2 / C 2 + 0.02 * C 2 conc - 2.8E-003 * C 8 conc - 2.8E-005 ⋆ {P}_{RPM}$$

where H2/C2 is the molar ratio of the hydrogen to the ethylene introduced to the reactor, C2 conc is the ethylene concentration in wt %, C8 conc is the at least one other comonomer concentration (e.g., octene concentration) in wt %, and PRPM is the pump speed in the reactor, with all weight percentages being based on the total weight of the solution being introduced to the reactor. The long chain branching index can be controlled based on the calculated g′(Mz).

### Polymerization Process

The polymerization process can be a solution polymerization process in which the monomer, the comonomer, and the catalyst system are contacted in a solution phase and polymer is formed therein. Preferably, the solution polymerization process is a bulk polymerization process. As used hererin, “bulk polymerization” refers to a polymerization process in which the monomers and/or comonomers being polymerized are used as a solvent or diluent using little or no inert solvent as a liquid or diluent. A small fraction of inert solvent might be used as a carrier for a catalyst and a scavenger.

In a preferred embodiment, the feed concentration of the monomers and comonomers for the polymerization is 60 vol % or less, preferably 40 vol % or less, or more preferably 20 vol % or less, based on the total volume of the feedstream.

### The Monomer and Comonomer

The olefin monomer can be or can include substituted or unsubstituted C2 to C40 olefins, preferably C2 to C20 olefins, more preferably C2 to C12 olefins, such as ethylene, propylene, butene, pentene, hexene, heptene, octene, nonene, decene, undecene, dodecene, and isomers thereof. The at least one other olefin comonomer can be or can include substituted or unsubstituted C4 to C40 olefins, preferably C4 to C20 olefins.

In one or more embodiments, the monomer can be ethylene, and the at least one other comonomer can include C4 to C20 olefins. The C4 to C20 olefins comonomers can be linear, branched, or cyclic. Suitable C4 to C20 cyclic olefins can be strained or unstrained, monocyclic or polycyclic, and can optionally include heteroatoms and/or one or more functional groups. The reactor C2 concentration can range from 0.1 to 40.0 wt % while the reactor comonomer concentration can range from 0.1 to 40.0 wt %.

Specific examples of the at least one comonomer include butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, preferably norbornene, norbornadiene, and dicyclopentadiene.

In a preferred embodiment, one or more dienes (diolefin monomer) are added to the polymerization process. The diene can be present in the polymer produced herein at up to 10 wt %, preferably at 0.00001 to 8.0 wt %, preferably 0.002 to 8.0 wt %, even more preferably 0.003 to 8.0 wt %, based upon the total weight of the composition. In some embodiments, 500 ppm or less of diene is added to the polymerization, preferably 400 ppm or less, preferably 300 ppm or less. In other embodiments, at least 50 ppm of diene is added to the polymerization, or 100 ppm or more, or 150 ppm or more.

Suitable diolefin monomers include any hydrocarbon structure, preferably C4 to C30, having at least two unsaturated bonds, where at least one of the unsaturated bonds are readily incorporated into a polymer chain during chain growth. It is further preferred that the diolefin monomers be selected from alpha, omega-diene monomers (i.e., di-vinyl monomers). More preferably, the diolefin monomers are linear di-vinyl monomers, most preferably those containing from 4 to 30 carbon atoms. Specific examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, 5-vinyl-2-norbornene, norbornadiene, 5-ethylidene-2-norbornene, divinylbenzene, and dicyclopentadiene or higher ring containing diolefins with or without substituents at various ring positions.

### Catalyst System

The term “catalyst system” means a catalyst precursor/activator pair. When “catalyst system” is used to describe such a pair before activation, it means the unactivated catalyst (pre-catalyst) together with an activator and, optionally, a co-activator. When it is used to describe such a pair after activation, it means the activated catalyst and the activator or other charge-balancing moiety. The transition metal compound may be neutral as in a pre-catalyst, or a charged species with a counter ion as in an activated catalyst system. The term “catalyst system” can also include more than one catalyst precursor and/or more than one activator and optionally a co-activator.

The catalyst system used for the polymerization process described herein can include a bridged metallocene compound having a single substituted carbon or silicon atom bridging two ancillary monanionic ligands, such as substituted or unsubstituted cyclopentadienyl-containing (Cp) ligands and/or substituted and unsubstituted Group 13-16 heteroatom ligands, of the metallocene metal centers. The bridge substituents can be substituted aryl groups, the substituents including at least one solubilizing hydrocarbylsilyl substituent located on at least one of the aryl group bridge substituents. Substituents present on the cyclopentadienyl and/or heteroatom ligands can include Cₜ-C₃₀ hydrocarbyl, hydrocarbylsilyl, or hydrofluorocarbyl groups as replacements for one or more of the hydrogen groups on those ligands, or those on fused aromatic rings on the cyclopentadienyl rings. Aromatic rings can be substituents on the cyclopentadienyl ligands and are inclusive of the indenyl and fluorenyl derivatives of cyclopentadienyl groups and their hydrogenated counterparts. Such aromatic rings typically include one or more aromatic ring substituents selected from linear, branched, cyclic, aliphatic, aromatic or combined structure groups, including fused-ring or pendant configurations. Examples include methyl, isopropyl, n-propyl, n-butyl, isobutyl, tertiary butyl, neopentyl, phenyl, n-hexyl, cyclohexyl, benzyl, and adamantyl. As used herein, the term “hydrocarbon” or “hydrocarbyl” is meant to include those compounds or groups that have essentially hydrocarbon characteristics but optionally contain not more than about 10 mol % non-carbon heteroatoms, such as boron, silicon, oxygen, nitrogen, sulfur, and phosphorous. Additionally, the term is meant to include hydrofluorocarbyl substituted groups. “Hydrocarbylsilyl” is exemplifyed by, but not limited to, dihydrocarbyl- and trihydrocarbylsilyls, where the preferred hydrocarbyl groups are Cₜ-C₃₀ substituent hydrocarbyl, hydrocarbylsilyl or hydrofluorocarbyl substitutents for the bridging group phenyls. For heteroatom containing catalysts, see International Publication No. WO 92/00333. Also, the use of hetero-atom containing rings or fused rings, where a non-carbon Group 13, 14, 15 or 16 atom replaces one of the ring carbons is considered herein to be within the terms “cyclopentadienyl”, “indenyl”, and “fluorenyl”. See, for example, the background and teachings of International Publication Nos. WO 98/37106 and WO 98/41530, which are incorporated herein by reference.

Particularly suitable cyclopentadienyl-based complexes are the compounds, isomers, or mixtures, of (para-trimethylsilylphenyl)(para-n-butylphenyl)methylene (fluorenyl) (cyclopentadienyl) hafnium dimethyl, di(para-trimethylsilylphenyl)methylene (2,7-di-tertbutyl fluorenyl) (cyclopentadienyl) hafnium dimethyl, di(para-triethylsilylphenyl)methylene (2,7-di-tertbutyl-fluorenyl) (cyclopentadienyl) hafnium dimethyl, (para-triethylsilylphenyl) (para-t-butylphenyl) methylene (2,7-di tertbutyl fluorenyl) (cyclopentadienyl) hafnium dimethyl or dibenzyl, and di(para-triethylsilyl-phenyl)methylene (2,7-dimethylfluorenyl)(cyclopentadienyl) hafnium dimethyl or dibenzyl.

The bridged metallocene compounds can be activated for polymerization catalysis in any manner sufficient to allow coordination or cationic polymerization. This can be achieved for coordination polymerization when one ligand can be abstracted and another will either allow insertion of the unsaturated monomers or will be similarly abstractable for replacement with a ligand that allows insertion of the unsaturated monomer (labile ligands), e.g., alkyl, silyl, or hydride. The traditional activators of coordination polymerization art are suitable, for example, Lewis acids such as alumoxane compounds, and ionizing, anion precursor compounds that abstract one so as to ionize the bridged metallocene metal center into a cation and provide a counter-balancing noncoordinating anion.

The catalyst system may also incorporate other types of single site catalyst, such as half-metallocenes and post-metallocenes. See also International Publication Nos. WO/2000/024793 and WO/2021/162748, each of which is incorporated herein by reference, for detailed descriptions of suitable catalyst systems.

### Tubular Reactor System

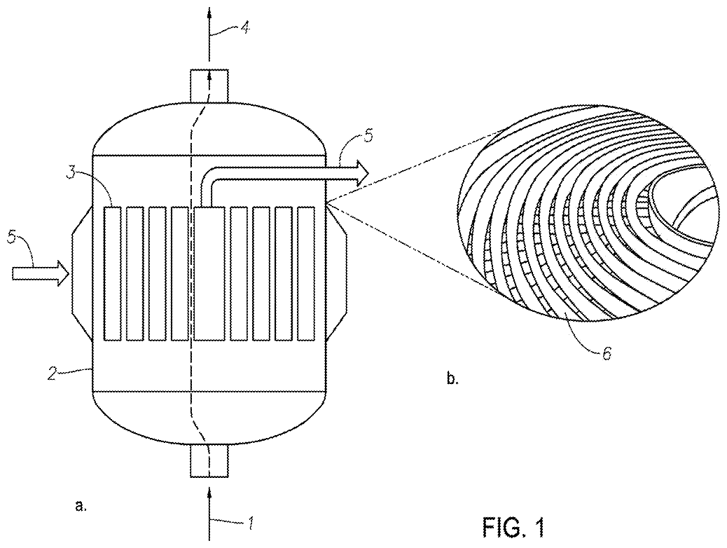

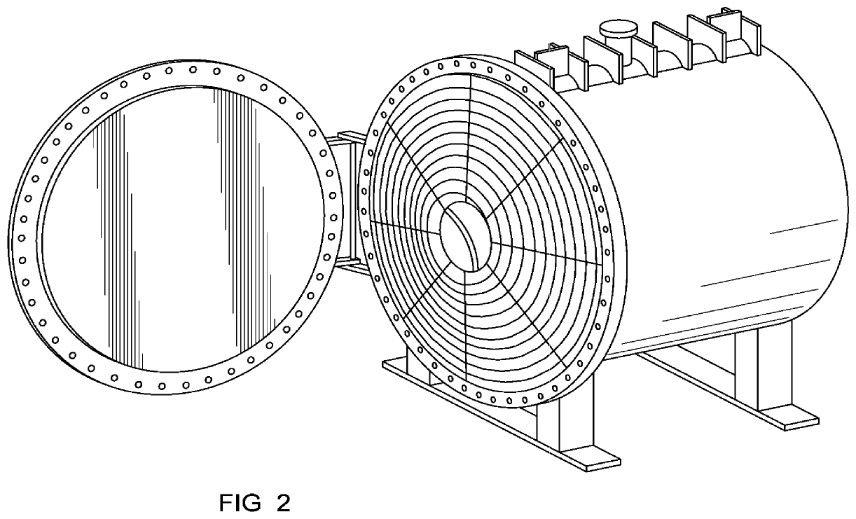

The tubular reactor system can include one or more spiral heat exchangers. For example, as shown in FIG. 1a, a stream 1 including monomer, comonomer, and catalyst system can enter a tubular reactor 2 and travel through a spiral heat exchanger 3. A stream 4 comprising copolymer product, unreacted monomer and/or comonomer, and quenched or unquenched catalyst system can exit the reactor 2. A stream 5 comprising heat exchange medium can flow through the spiral heat exchanger 3. The at least one spiral heat exchanger can include a body formed by at least one spiral sheet wound to form spirals which are arranged radially around an axis of the spiral heat exchanger. The spirals can form at least one flow channel for flow of a heat exchange medium, and the spirals can be enclosed by a substantially cylindrical shell, as shown in FIG. 2. Also, the cylindrical shell can include at least one inlet and at least one outlet in fluid communication with the at least one flow channel for providing and removing the heat exchange medium.

The at least one spiral heat exchanger can be oriented in a direction, for example, as shown in FIG. 1b, such that the monomer, comonomer, catalyst system, and copolymer product flow in an axial direction through channels formed in between the spirals 6 of the at least one spiral heat exchanger, thereby the feed and the polymer product as it travels through the at least one spiral heat exchanger. In other words, the monomer, comonomer, catalyst system, and copolymer product can flow through the at least one spiral heat exchanger in a cross-flow direction relative to the spirals of the at least one spiral heat exchanger. As used herein, “cross-flow” direction refers to a flow substantially orthogonal in direction to the spirals of the at least one spiral heat exchanger. Substantially orthogonal can include flow of the monomer, comonomer, catalyst system, and copolymer product at an angle of 700 to 110°, preferably 800 to 100°, more preferably 85° to 95°, even more preferably 88° to 92°, or most preferably 90°, with respect to the spirals of the at least one spiral heat exchanger.

As shown in FIG. 1b, the at least one spiral exchanger can be oriented in a substantially vertical direction such that the monomer, comonomer, catalyst system, and copolymer product flow in a substantially vertical direction through the at least one spiral heat exchanger. The orientation of the at least one spiral heat exchanger is not limited to such a vertical orientation but rather can be oriented in any direction so long as the feed and product flow through the at least one spiral heat exchanger in a cross-flow direction relative to the spirals of the at least one spiral heat exchanger. For example, the at least one spiral heat exchanger can be oriented in a substantially horizontal direction, as shown in FIG. 2, such that the monomer, comonomer, catalyst system, and copolymer product flow through the at least one spiral heat exchanger in a substantially horizontal direction.

Alternatively, the at least one spiral heat exchanger can include multiple spiral heat exchangers, e.g., at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, etc.

The at least one spiral heat exchanger used in the processes described herein can be any suitable spiral heat exchanger known in the art. Non-limiting examples of suitable spiral heat exchangers include those described in U.S. Pat. Nos. 8,622,030; 8,075,845; 8,573,290; 7,640,972; 6,874,571; 6,644,391; 6,585,034; and 4,679,621; US Publication Nos. 2010/0170665; 2010/0008833; 2002/0092646; and 2004/0244968, and International Publication No. WO/2017/058385, each of which are incorporated herein by reference. Additionally or alternatively, the at least one spiral heat exchanger can have a surface area to volume ratio of about 20-30 ft2/ft3. Advantageously, the spiral heat exchanger can have an open channel height of 0.5 to 30 feet, preferably 1 to 25 feet, 3 to 20 feet, 5 to 15 feet, or 5 to 10 feet.

The heat exchange medium that flows through the spirals of the at least one spiral heat exchanger can be any suitable heat exchange medium known in the art. Particularly useful heat exchange media are those stable at the reaction temperatures and typically include those stable at 200° C. or more. Examples of heat transfer media include water and other aqueous solutions, oil (e.g., hydrocarbons, such as mineral oil, kerosene, hexane, pentane, and the like), and synthetic media, such as those commercially available from The Dow Chemical Company (Midland, Michigan) under the trade name DOWTHERM™, such as grades A, G, J, MX, Q, RP, and T. If water is used, then the water is preferably under a suitable amount of pressure to prevent boiling. Preferably, the heat exchange medium flows through the spirals at a temperature lower than a temperature of the feed stream. Additionally, or alternatively, the heat exchange medium can flow through the spirals at a temperature above a precipitation point of the polymer. For example, the heat exchange medium can flow through the spirals at a temperature of 100° C. to 150° C., preferably 120° C. to 140° C., or more preferably 130° C.

In various aspects, the at least one spiral heat exchanger can remove heat (e.g., produced during the polymerization reaction) at a rate of >about 100 Btu/hour-cubic foot-° F. (about 1,860 W/cubic meters-° C.), >about 150 Btu/hour-cubic foot-° F. (about 2,795 W/cubic meters-° C.), >about 200 Btu/hour-cubic foot-° F. (about 3,725 W/cubic meters-° C.), >about 250 Btu/hour-cubic foot-° F. (about 4,660 W/cubic meters-° C.), >about 300 Btu/hour-cubic foot-° F. (about 5,590 W/cubic meters-° C.), >about 350 Btu/hour-cubic foot-° F. (about 6,520 W/cubic meters-° C.), >about 400 Btu/hour-cubic foot-° F. (about 7,450 W/cubic meters-° C.), >about 450 Btu/hour-cubic foot-° F. (about 8,385 W/cubic meters-° C.), >about 500 Btu/hour-cubic foot-° F. (about 9,315 W/cubic meters-° C.), >about 550 Btu/hour-cubic foot-° F. (about 10,245 W/cubic meters-° C.), >about 600 Btu/hour-cubic foot-° F. (about 11,180 W/cubic meters-° C.), >about 650 Btu/hour-cubic foot-° F. (about 12,110 W/cubic meters-° C.), >about 700 Btu/hour-cubic foot-° F. (about 13,040 W/cubic meters-° C.), >about 750 Btu/hour-cubic foot-° F. (about 13,970 W/cubic meters-°C.), or >about 800 Btu/hour-cubic foot-° F. (about 14,905 W/cubic meters-° C.). Preferably, the at least one spiral heat exchanger removes heat at a rate of about >400 Btu/hour-cubic foot-° F. (about 7,450 W/cubic meters-° C.). Ranges expressly disclosed include combinations of any of the above-enumerated values, e.g., about 100 to about 800 Btu/hour-cubic foot-° F. (about 1,860 to about 14,905 W/cubic meters-° C.), about 200 to about 650 Btu/hour-cubic foot-° F. (about 3,725 to about 12,110 W/cubic meters-° C.), about 350 to about 550 Btu/hour-cubic foot-° F. (about 6,520 to about 10,245 W/cubic meters-° C.). Preferably, the at least one spiral heat exchanger removes heat at a rate of about 100 to about 800 Btu/hour-cubic foot-° F. (about 1,860 to about 14,905 W/cubic meters-° C.), preferably about 200 to about 700 Btu/hour-cubic foot-° F. (about 3,725 to about 13,040 W/cubic meters-° C.), or more preferably about 300 to about 500 Btu/hour-cubic foot-° F. (about 5,590 to about 9,315 W/cubic meters-° C.).

Additionally, use of the at least one spiral heat exchanger in the polymerization process described herein advantageously results in a low pressure drop, which results in higher recirculation and production rates. For example, the pressure drop across the at least one spiral heat exchanger can be <about 0.1 psi, <about 0.2 psi, <about 0.3 psi, <about 0.4 psi, <about 0.5 psi, <about 0.6 psi, <about 0.7 psi, <about 0.8 psi, <about 0.9 psi, <about 1.0 psi, <about 2.0 psi, <about 3.0 psi, <about 4.0 psi, <about 5.0 psi, <about 6.0 psi, <about 7.0 psi, <about 8.0 psi, <about 9.0 psi, <about 10.0 psi, <about 12.0 psi, <about 14.0 psi, <about 16.0 psi, <about 18.0 psi, or <about 20.0 psi. The pressure drop across the at least one spiral heat exchanger can be <about 10.0 psi, preferably <about 5.0 psi, or more preferably <about 1.0 psi. Ranges expressly disclosed include combinations of any of the above-enumerated values, e.g., about 0.1 psi to about 20.0 psi, about 0.5 psi to about 16.0 psi, about 1.0 psi to about 12 psi, about 3.0 psi to about 8.0 psi, etc. Preferably, pressure drop across the at least one spiral heat exchanger is about 0.1 psi to about 14.0 psi, more preferably about 0.5 psi to about 10.0 psi, or even more preferably about 0.8 psi to about 2.0 psi, or alternately from 0.2 to 0.8 psi per stage.

In various aspects, the monomer, the comonomer, the catalyst system, and the polymer can be maintained substantially as a single liquid phase under polymerization conditions. Preferably, the flow of the liquid through the at least one spiral heat exchanger can be substantially laminar or near-laminar. Preferably, the Reynolds number of the flow of the liquid can be >about 0.1, >about 1.0, >about 10.0, >about 20.0, >about 30.0, >about 40.0, >about 50.0, >about 60.0, >about 70.0, >about 80.0, >about 90.0, >about 100, >about 200, >about 300, >about 400, >about 500, >about 600, >about 700, >about 800, >about 900, >about 1,000, >about 1,100, >about 1,200, >about 1,300, >about 1,400, >about 1,500, >about 1,600, >about 1,700, >about 1,800, >about 1,900, >about 2,000, >about 2,100, or about 2,200. Additionally or alternatively, the Reynolds number of the flow of the liquid can be <about 40.0, <about 50.0, <about 60.0, ≤about 70.0, ≤about 80.0, ≤about 90.0, ≤about 100, ≤about 200, <about 300, ≤about 400, ≤about 500, ≤about 600, ≤about 700, ≤about 800, ≤about 900, ≤about 1,000, ≤about 1,100, ≤about 1,200, ≤about 1,300, ≤about 1,400, ≤about 1,500, ≤about 1,600, ≤about 1,700, ≤about 1,800, ≤about 1,900, ≤about 2,000, ≤about 2,100 or <about 2,200. Ranges expressly disclosed include combinations of any of the above-enumerated values, e.g., about 0.1 to about 2,200, about 1.0 to about 1,400, about 1.0 to about 100, about 50.0 to about 900, etc. Preferably, the Reynolds number of the liquid is about 0.1 to about 2,200, preferably about 1.0 to about 1,000, preferably about 1.0 to about 100, more preferably about 1.0 to about 50. Reynolds number is calculated using the hydraulic diameter (Dh) and the hydraulic diameter (Dh) and is defined as Dh=4A/P, where A is the cross-sectional area and P is the wetted perimeter of the cross-section of a channel in the spiral heat exchanger. Zero shear viscosity is used for Reynolds number calculation when a non-Newtonian fluid is used.

The polymerization process can be conducted at a temperature of from about 50° C. to about 220° C., preferably from about 70° C. to about 210° C., preferably from about 90° C. to about 200° C., preferably from about 100° C. to about 190° C., or preferably from about 130° C. to about 160° C. The polymerization process can be conducted at a pressure of from about 120 to about 1,800 psi (827.371 to 12, 410.560 kPa), preferably from about 200 to about 1,000 psi (1,378.950 to 6,894.760 kPa), preferably from about 300 to about 800 psi (2,068.430 to 5,515.810 kPa).

In various aspects, residence time in the at least one spiral heat exchanger can be up to 24 hours or longer, typically from about 1 minute to about 15 hours. The residence time is preferably from about 2 minutes to about 1 hour, from about 3 to about 30 minutes, from about 5 to about 25 minutes, or from about 5 to about 20 minutes.

In a some embodiments, hydrogen can be present during the polymerization process at a partial pressure of from about 0.001 to about 50.000 psig (0.007 to 344.738 kPa), preferably from about 0.010 to about 25.000 psig (0.069 to 172.369 kPa), more preferably from about 0.100 to about 10.000 psig (0.689 to 482.633 kPa). Alternatively, the hydrogen concentration in the feed can be 500 wppm or less, preferably 200 wppm or less.

In various aspects, the cement concentration of the polymer produced can range from about 2 wt % to about 40 wt %, preferably from about 5 wt % to about 30 wt %, or more preferably from about 6 wt % to about 25 wt %. “Cement concentration” is herein defined to be the weight of the polymer produced based on the weight of the total solvent (e.g., monomer, comonomer, and/or solvent).

The polymerization process can further include recycling at least a portion of the solvent, the monomer/comonomer, the catalyst system, and the polymer within the tubular reactor back through the tubular reactor. Polymer can be produced with a recycle ratio ranging from about 3 to about 50, preferably from about 3 to about 30, or more preferably from about 3 to about 20. The recycle ratio is herein defined to be the ratio between the flow rate of the recycle loop just prior to entry into the spiral heat exchanger (alone or in series) divided by the flow rate of fresh feed to the spiral heat exchanger (alone or in series).

### Examples

The foregoing discussion can be further described with reference to the following non-limiting examples.

Seven samples (Examples 1-3) of copolymers of ethylene (C2) and octene (C8) were made as follows using a tubular reactor (“TR”) and a single metallocene-based catalyst system. A catalyst activator (dimethylanilinium tetrakis(pentaflourophenyl) borate), hydrogen (H₂), and ethylene (C2) monomer were added to the reactor. A hafnium-based metallocene (MCN) catalyst (as disclosed in paragraph [0063]), octene (C8) comonomer, and hexene (C6) were then added to the reactor to start the slurry phase polymerization. The amounts of C2, C8, C6, and H₂ being fed to the reactor were kept constant throughout the polymerization process. The process conditions employed for Ex.1-7 are shown in Table 1 below.

C2/C8 copolymers commercially available from ExxonMobil (Comparative Examples 1 and 2), which were made using an MCN catalyst and a CSTR reactor, were obtained for comparison purposes. The following C2/C8 copolymers were also obtained for comparison purposes: Engage™ 8150, Engage™ 11547, and Affinity™ PL 1880 (Comparative Examples 3, 4, and 6, respectively) commercially available from Dow Chemical Co.; and Queo™ 06201 (Comparative Example 5) commercially available from Borealis AG.

TABLE 1
Process Conditions for Ex. 1-7

| Example | Ex. 1 | Ex. 2 | Ex. 3 | Ex. 4 | Ex. 5 | Ex. 6 | Ex. 7 |
|---|---|---|---|---|---|---|---|
| Catalyst Flow | 1.808 | 2.109 | 2.208 | 2.207 | 2.608 | 2.622 | 2.608 |
| (cc/min) | | | | | | | |
| Activator Flow | 0.183 | 0.416 | 0.416 | 0.213 | 0.225 | 0.272 | 0.374 |
| (cc/min) | | | | | | | |
| Reactor Inlet | 131.690 | 152.722 | 124.473 | 124.737 | 139.186 | 138.811 | 147.315 |
| Temp. (° C.) | | | | | | | |
| Reactor Outlet | 134.654 | 157.629 | 125.816 | 127.291 | 142.702 | 142.534 | 151.685 |
| Temp. (° C.) | | | | | | | |
| Reactor Press. | 550 | 550 | 550 | 550 | 550 | 550 | 550 |
| (psig) | | | | | | | |
| C6 Feed (kg/hr) | 37.990 | 37.730 | 29.993 | 40.860 | 40.823 | 40.803 | 40.999 |
| C8 Feed (kg/hr) | 2.580 | 2.320 | 2.385 | 1.999 | 2.000 | 1.800 | 1.650 |
| C2 Feed (kg/hr) | 5.270 | 4.851 | 4.851 | 5.400 | 5.798 | 5.499 | 5.200 |
| H₂ Feed | 354.686 | 150.002 | 150.004 | 269.998 | 268.022 | 205.371 | 82.000 |
| (sccm) | | | | | | | |
| Cement Conc. | 12.55 | 13.60 | 17.49 | 12.11 | 13.07 | 12.64 | 12.74 |
| (wt %) | | | | | | | |
| H₂/C2 Feed | 336.65 | 156.15 | 159.77 | 256.36 | 236.96 | 191.50 | 80.10 |
| (wppm) | | | | | | | |
| C2 Conversion | 80 | 90 | 90 | 83 | 85 | 86 | 90 |
| (%) | | | | | | | |

The C8 content, molecular moments, densities, and LCB index, MI, MIR, and solubility distribution breadth index (SDBI) values of the samples of Ex.1-7 and C.Ex.1-6 are presented in Tables 2-3 below. The densities of Ex.1-3 ranged from 0.882 to 0.886 g/cc, and the MI values of Ex. 1-3 ranged from 2.4 to 15.8 dg/min. The MWDs (Mw/Mn) of the samples of Ex.2-3 were higher than those of C.Ex.1 and Ex.1 even though they had similar densities. The densities of Ex.4-7 were higher than those of Ex.1-3, ranging from 0.892 to 0.895 g/cc. The change in MWD for the samples of Ex.4-7 was very apparent when the MIR (MI_{21.6}/MI_{2.16}) was progressively changed from 26 to 53, as shown in Table 2. The inventive sample of Ex. 7 surprisingly exhibited a broader MWD (2.6) and a lower LCB index (g′(Mz)) than the samples of Ex.4-6 and C.Ex.2. The branching index g′ (Mz) was the g′ from GPC-4D estimated at the z-average (third moment) molecular weight average. This calculation was performed by curve fitting the g′ vs molecular weight data to a nth order polynomial using the MATLAB program. The value of n was typically between 3 and 4. The Mz value obtained from GPC-IR measurements was inserted into the curve fit to calculate the g′ associated with that molecular weight.

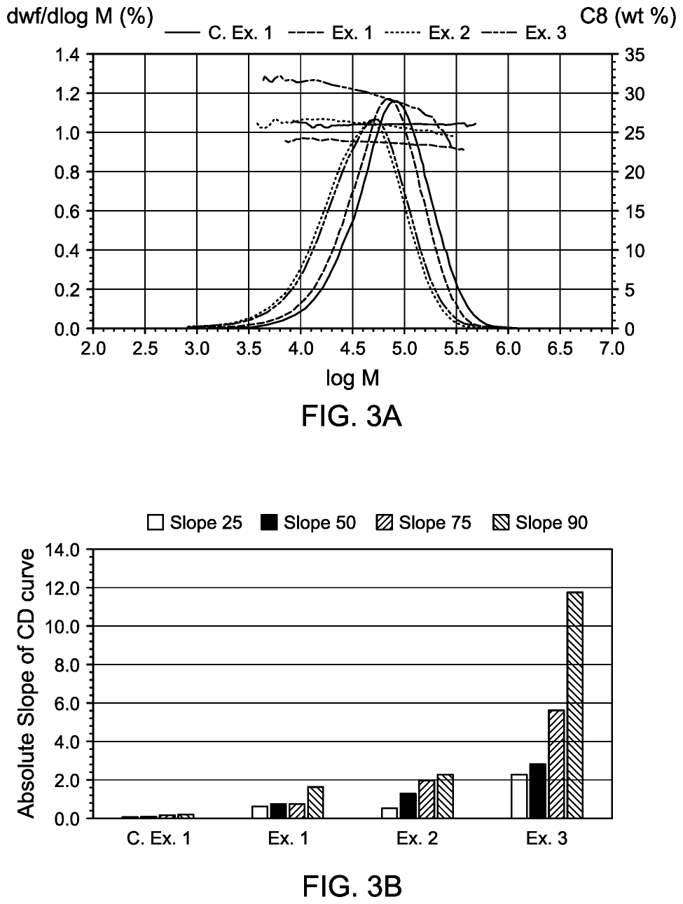

FIGS. 3a and 3b depict graphs of the molecular weight distribution and comonomer distributions of the samples of Ex.1-3 and C.Ex1. In FIG. 3b, the comonomer distribution is represented as the slopes 25, 50, 75, and 90 calculated from the slopes of the comonomer distribution curve estimated at 25%, 50%, 75% and 90% of the molecular weight, respectively. The slopes were determined by first curve fitting the comonomer content versus molecular weight variation to a nth order polynomial using the MATLAB program. The value of n ranges was typically between 2 and 4. The derivative of the curve were obtained at various molecular weight points, which are 25%, 50%, 75% and 90%, respectively, of the range of molecular weight. For example, to determine the 25% point on the x-axis, the difference between the molecular weight minimum (mwmin) and molecular weight maximum (mwmax) for the specific data set was first established. The xvalue of slope 25 was calculated as mwmin+0.25*(mwmax-mwmin). The absolute value of the derivative was determined at that point to find slope 25. Slope values ranging from 0 to 2 were considered to represent a uniform comonomer distribution, whereas slopes >2 were considered to represent a non-uniform comonomer distribution. The slope 25, slope 50, slope 75, slope 90, and the average of slope 50 and slope 75 for the samples of Ex.1-7 and C.Ex.1-6 are depicted in Table 2-3 below. As illustrated in FIG. 3b, the inventive sample of Ex. 3 unexpectedly exhibited a significant increase in slope (>2), indicating a broad distribution of comonomer where the high molecular weight chains have lower comonomer content and the low molecular weight chains have higher comonomer content. Also, as shown in Tables 2-3, the inventive samples of Ex.3 and Ex.7 had much greater average slopes than the samples of C.Ex.1-6, Ex. 1-2, and Ex. 4-6. Additionally, the change in composition distribution for the samples of Ex.4-7 was very apparent when the MIR was progressively changed from 26 to 53, as shown in Table 2.

TABLE 2
Properties of the C2/C8 Copolymer Samples of Ex. 1-7 and C. Ex. 1-2

| Example | C. Ex. 1 | Ex. 1 | Ex. 2 | Ex. 3 | C. Ex. 2 | Ex. 4 | Ex. 5 | Ex. 6 | Ex. 7 |
|---|---|---|---|---|---|---|---|---|---|
| Reactor Type | CSTR | TR | TR | TR | TR | TR | TR | TR | TR |
| Catalyst | MCN | MCN | MCN | MCN | MCN | MCN | MCN | MCN | MCN |
| Comonomer | C8 | C8 | C8 | C8 | C8 | C8 | C8 | C8 | C8 |
| Density (g/cc) | 0.884 | 0.886 | 0.882 | 0.876 | 0.900 | 0.892 | 0.895 | 0.895 | 0.894 |
| MI (dg/min) | 1.1 | 2.4 | 15.8 | 13.7 | 1.1 | 1.1 | 1.2 | 1.2 | 1.1 |
| MIR | 35 | 22 | 33 | 35 | 35 | 26 | 31 | 35 | 53 |
| Mn (g/mol) | 45,600 | 39,200 | 21,965 | 24,485 | 38,286 | 45,868 | 39,139 | 36,843 | 30,000 |
| Mw (g/mol) | 99,700 | 83,600 | 52,577 | 58,666 | 83,658 | 97,531 | 86,896 | 83,766 | 77,927 |
| Mz (g/mol) | 171,500 | 152,300 | 94,995 | 113,263 | 144,738 | 166,680 | 151,813 | 148,545 | 159,204 |
| Mw/Mn | 2.2 | 2.1 | 2.4 | 2.4 | 2.2 | 2.1 | 2.1 | 2.3 | 2.6 |
| Mz/Mw | 1.7 | 1.8 | 1.8 | 1.9 | 1.7 | 1.7 | 1.7 | 1.8 | 2.0 |
| Mz/Mn | 3.8 | 3.9 | 4.3 | 4.6 | 3.8 | 3.6 | 3.9 | 4.0 | 5.3 |
| Comonomer (wt %) | 26.2 | 23.7 | 26.2 | 29.7 | 17.9 | 21.0 | 19.6 | 19.3 | 19.5 |
| LCB | 0.925 | 0.940 | 0.895 | 0.915 | 0.940 | 0.950 | 0.936 | 0.933 | 0.896 |
| g′-Mz | | | | | | | | | |
| LCB | 0.898 | 0.937 | 0.858 | 0.926 | 0.935 | 0.935 | 0.915 | 0.911 | 0.869 |
| g′-Mz + 1 | | | | | | | | | |
| Slope 25 | 0.13 | 0.30 | 0.60 | 1.30 | 1.57 | 0.31 | 0.42 | 0.11 | 0.48 |
| Slope 50 | 0.35 | 0.70 | 1.30 | 2.70 | 0.09 | 1.83 | 0.97 | 1.61 | 1.90 |
| Slope 75 | 0.02 | 1.00 | 2.00 | 6.60 | 1.16 | 0.98 | 2.12 | 2.32 | 4.64 |
| Slope 90 | 0.56 | 1.10 | 2.00 | 10.00 | 1.52 | 0.67 | 3.09 | 2.25 | 6.92 |
| SDBI (° C.) | 16.6 | 18.4 | 20.0 | 20.0 | 18.0 | 18.5 | 16.6 | 19.5 | 19.7 |
| (Slope 50 + | 0.2 | 0.9 | 1.7 | 4.6 | 0.6 | 1.4 | 1.5 | 2.0 | 3.3 |
| Slope75)/2 | | | | | | | | | |
| (Slope 25 + | 0.2 | 0.5 | 0.9 | 2.0 | 0.8 | 1.1 | 0.7 | 0.9 | 1.2 |
| Slope 50)/2 | | | | | | | | | |
| (Slope 75 + | 0.3 | 1.0 | 2.0 | 8.3 | 1.3 | 0.8 | 2.6 | 2.3 | 5.8 |
| Slope 90)/2 | | | | | | | | | |

TABLE 3
Properties of the C2/C8 Copolymer Samples of C.Ex.3-6

| Example | C.Ex.3 | C.Ex.4 | C.Ex.5 | C.Ex6 |
|---|---|---|---|---|
| Reactor Type | Unknown | Unknown | Unknown | Unknown |
| Catalyst | Unknown | Unknown | Unknown | Unknown |
| Comonomer | C8 | C8 | C8 | C8 |
| Density (g/cc) | 0.868 | 0.866 | 0.862 | 0.902 |
| MI (dg/min) | 0.5 | 5.0 | 1.0 | 1.0 |
| Mn (g/mol) | 63,630 | 38,326 | 57,051 | 40,535 |
| Mw (g/mol) | 155,684 | 98,797 | 139,390 | 87,306 |
| Mz (g/mol) | 277,717 | 172,425 | 252,696 | 152,493 |
| Mw/Mn | 2.4 | 2.6 | 2.4 | 2.2 |
| Mz/Mw | 1.8 | 1.7 | 1.8 | 1.7 |
| Mz/Mn | 4.4 | 4.5 | 4.4 | 3.8 |
| Comonomer | 36.3 | 40.9 | 39.0 | 14.7 |
| (wt %) | | | | |
| LCB | 0.970 | 0.940 | 0.920 | 0.940 |
| g′-Mz | | | | |
| LCB | 0.970 | 0.960 | 0.900 | 0.920 |
| g′-Mz + 1 | | | | |
| Slope 25 | 1.39 | 9.36 | 4.26 | 0.17 |
| Slope 50 | 2.54 | 3.68 | 1.44 | 1.75 |
| Slope 75 | 3.11 | 0.68 | 0.33 | 0.89 |
| Slope 90 | 3.17 | 0.17 | 0.89 | 0.96 |
| SDBI | 16.7 | 39.5 | 24.3 | 16.4 |
| (Slope 50 + | 2.8 | 2.2 | 0.9 | 1.3 |
| Slope 75)/2 | | | | |
| (Slope 25 + | 2.0 | 6.5 | 2.8 | 1.0 |
| Slope 50)/2 | | | | |
| (Slope 75 + | 3.1 | 0.4 | 0.6 | 0.9 |
| Slope 90)/2 | | | | |

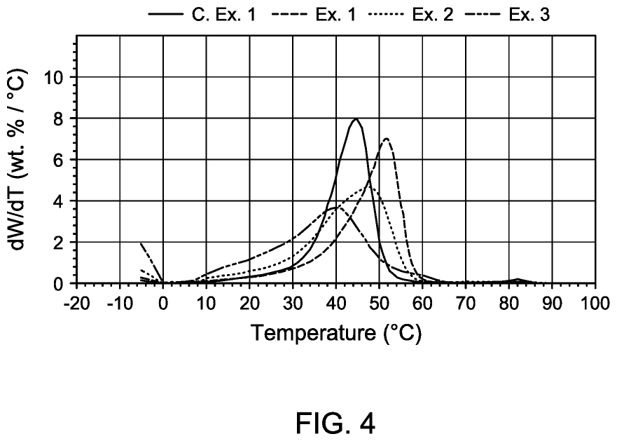

The samples of Ex.1-3 and C.Ex.1 were analyzed by the Temperature Rising Elution Fractionation$TREF) technique. FIG. 4 depicts graphs of the TREF distribution profiles for each of these samples. FIG. 4 reinforces the GPC′ broader comonomer distribution profile for the inventive sample of Ex.3. The progressive increase in slope and the corresponding broadening of composition is particularly noticeable for the samples of Ex.1, Ex.2, and Ex.3 when compared to the sample of C.Ex.1. This change in composition is mainly due to variation in cement concentration, conversion, and temperature that affects both MWD and composition distribution.

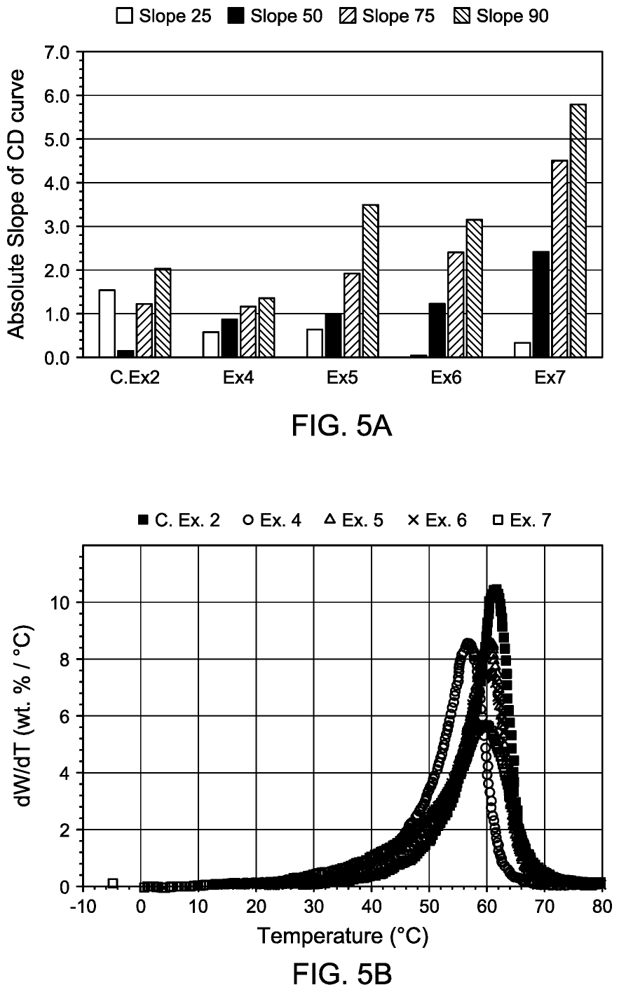

The composition distributions as estimated from the slopes of the GPC-4D comonomer profiles and the TREF distribution profiles for the samples of Ex.4-7 and C.Ex.2 are displayed in FIGS. 5a and 5b, respectively. The inventive sample of Ex.7 exhibited the greatest increase in slopes 50, 75, and 90, indicating a broad distribution of comonomer along the polymer chain. The TREF profiles reinforce the progressive increase in slope and the corresponding broadening of composition distribution for the samples of Ex.4-7, and C.Ex.2.

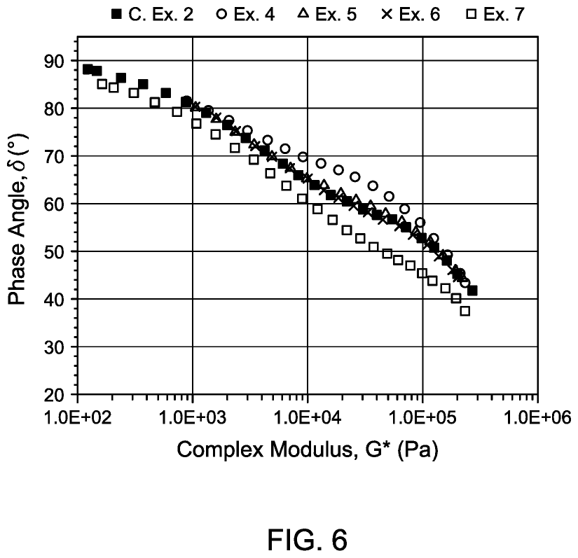

FIG. 6 depicts a van Gurp-Palment plot for the samples of Ex.4-7 and C.Ex.2. The aforementioned change in branching content is also supported by FIG. 6, which shows a decrease in phase angle (δ) at a constant modulus (G*) as the MIR was increased from 26 to 53 for the samples of Ex.4-7. Increasing levels of branching leads to a reduction in phase angle.

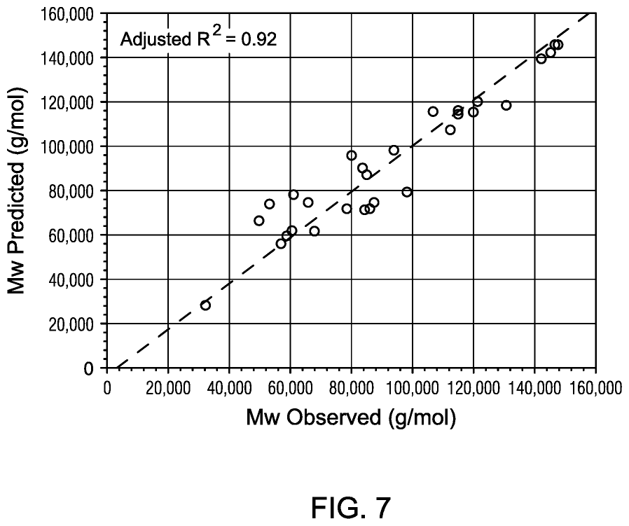

Based on the data collected for Ex.1-7, the weight average molecular weight was correlated with the C2 concentration in the reactor and the H2/C2 molar ratio to determine the following equation:

$${( Mw )}^{2.2} = - 2.1E+011 + 1.5E+9 * T avg - \text{} 2.7E+8 * H 2 / C 2 + 4.1E+10 * C 2 conc + 3.4E+011 * C 8 conc - 1.8E+9 * T avg * C 8 conc - 1.9E+010 * C 2 conc * C 8 conc$$

where T avg is the average of reactor inlet and outlet temperatures in ° C., H2/C2 is the molar ratio of the hydrogen to the ethylene introduced to the reactor, C2 conc is the ethylene concentration in wt %, and C8 conc is the 1-octene concentration in wt %, with all weight percentages being based on the total weight of the solution introduced to the reactor. The adjusted regression model fit, R², was 0.92. As used herein, the R² is a measure of the amount of variation about the mean explained by the model. Adjusted R2 is a predictor of model accuracy. A value of 1 indicates that the model perfectly predicts the data while 0 or negative indicates a model that has no predictive value. The relationship between Mw predicted versus Mw observed based on the correlation is shown in FIG. 7.

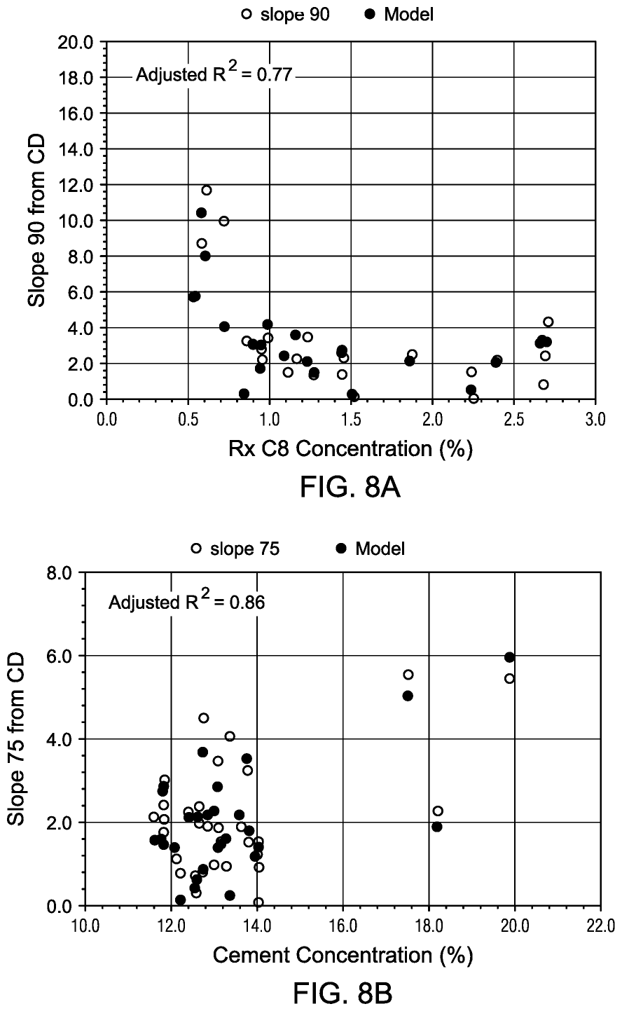

The composition distribution as estimated from the slopes of the comonomer distribution curves were correlated with the following process parameters: average reactor temperature, H₂/C2 molar ratio, C8 concentration in the reactor, and cement concentration to determine the following equations:

$$Sqrt ( Slope 90 ) = + 0 \text{.11} - 7.6E-003 * H 2 / C 2 + 0.5 * C 2 conc - 0.2 * C 8 conc + 0.2 * Cement conc ( Adjusted {R}^{2} = 0.77 ) ; and$$

$$Sqrt ( Slope 75 ) = + 2.6 - 0.011 ⋆ T avg - 5.7E-003 ⋆ H 2 / C 2 + 0.13 ⋆ C 2 conc - 0.06 ⋆ C 8 conc + 0.1 ⋆ Cement conc ( Adjusted {R}^{2} = 0.86 )$$

where T avg is the average of reactor inlet and outlet temperatures in ° C., H2/C2 is the molar ratio of the hydrogen to the ethylene introduced to the reactor, C2 conc is the ethylene concentration in wt %, and C8 conc is the 1-octene concentration in wt %, and Cement conc is the cement concentration in wt %, with all weight percentages being based on the total weight of the solution introduced to the reactor. FIGS. 8a and 8b show the relationship between the slopes 90 and 75 predicted versus the slopes 90 and 75 observed based on these correlations.

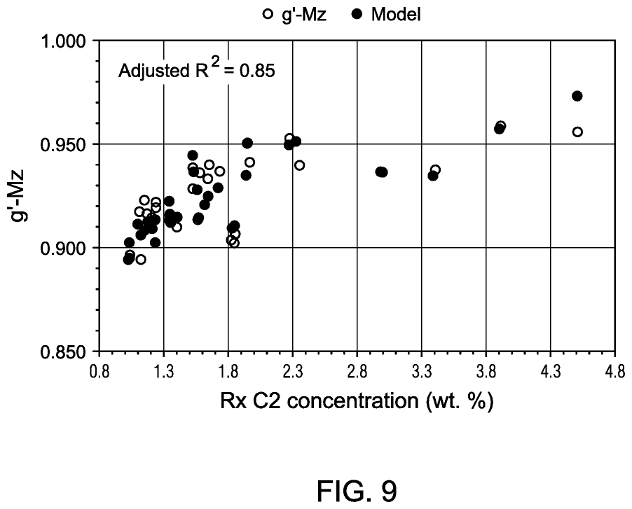

The branching index as measured using g′ (Mz) was also correlated with C2 and C8 concentrations in the reactor based on the following equation:

$${g}^{′} - Mz = + 0.89 + 1.47E-004 * H 2 / C 2 + 0.02 * C 2 conc - 2.8E-003 * C 8 conc - 2.8E-005 ⋆ {P}_{RPM} ( Adjusted {R}^{2} = 0.85 )$$

where H2/C2 is the molar ratio of the hydrogen to the ethylene introduced to the reactor, C2 conc is the ethylene concentration in wt %, and C8 conc is the 1-octene concentration in wt %, and P_{RPM} is the pump speed in the reactor, with all weight percentages being based on the total weight of the solution introduced to the reactor. FIG. 9 shows the relationship between g′(Mz) predicted and g′(Mz) observed based on this correlation as a function of ethylene concentration.

Seven samples (Examples 8-14) of copolymers of C2 and C4 (instead of C8) were made in the same manner as the samples of Ex.1-7. The process conditions for Ex.8-9 and Ex.11-14 are shown in Table 4 below. Samples of C2/C4 copolymers commercially available from ExxonMobil (Comparative Examples 1 and 2); (Comparative Examples 7 and 8), which are produced using a gas-phase reactor and a Ziegler-Natta (Z-N) catalyst, were obtained for comparison purposes.

TABLE 4
Process Conditions for Ex. 8-14

| Example | Ex. 8 | Ex. 9 | Ex. 11 | Ex. 12 | Ex. 13 | Ex. 14 |
|---|---|---|---|---|---|---|
| Catalyst Flow | 0.590 | 0.600 | 0.625 | 1.105 | 1.109 | 0.592 |
| (cc/min) | | | | | | |
| Activator Flow | 0.603 | 0.524 | 0.637 | 1.118 | 1.117 | 0.604 |
| (cc/min) | | | | | | |
| Reactor Inlet | 131.9 | 121.6 | 128.381 | 132.5 | 132.321 | 133.599 |
| Temp. (° C.) | | | | | | |
| Reactor Outlet | 135.4 | 124.6 | 129.9 | 135.9 | 135.058 | 136.960 |
| Temp. (° C.) | | | | | | |
| Reactor Press. | 540 | 536 | 608 | 535 | 537 | 538 |
| (psig) | | | | | | |
| C6 Feed | 32.423 | 30.506 | 29.363 | 33.330 | 32.487 | 32.222 |
| (kg/hr) | | | | | | |
| C4 Feed | 0.197 | 0.274 | 2.029 | 0.394 | 0.246 | 0.227 |
| (kg/hr) | | | | | | |
| C2 Feed | 3.092 | 3.060 | 5.370 | 3.499 | 3.413 | 3.091 |
| (kg/hr) | | | | | | |
| H₂ Feed | 23.057 | 62.487 | 120.019 | 250.026 | 75.004 | 23.084 |
| (sccm) | | | | | | |
| Cement Conc. | 8.7 | 7.4 | 19 | 9.1 | 9.4 | 8.723 |
| (wt %) | | | | | | |
| H₂/C2 Feed | 37.3 | 102 | 112 | 357.3 | 109.9 | 37.338 |
| (wppm) | | | | | | |
| C2 Conversion | 91.8 | 75.6 | 97.8 | 85.5 | 90.3 | 90.9 |
| (%) | | | | | | |

The C4 content, molecular moments, densities, and LCB index, MI, MIR, and SDBI values of the samples of Ex.8-14 and C.Ex.7-8 are presented in Table 5 below. The inventive samples of Ex.8-9 and Ex.13-14 unexpectedly exhibited relatively broad MWDs ranging from 3.5 to 4.9, which were higher than or comparable to the MWDs of the samples of C.Ex.7-8. Surprisingly, the inventive samples of Ex.8 and Ex.10-14 had broader comonomer distributions than the samples of C.Ex.7-8, as indicated by average slope values ranging from 2.1 to 5.7.

TABLE 5
Properties of the C2/C4 Copolymer Samples of Ex. 1-7 and C. Ex. 7-8

| Example | Ex. 8 | Ex. 9 | Ex. 10 | Ex. 11 | Ex. 12 | Ex. 13 | Ex. 14 | C. Ex. 7 | C. Ex. 8 |
|---|---|---|---|---|---|---|---|---|---|
| Reactor Type | TR | TR | TR | TR | TR | TR | TR | Gas | Gas |
| | | | | | | | | Phase | Phase |
| Catalyst | MCN | MCN | MCN | MCN | MCN | MCN | MCN | Z-N | Z-N |
| Comonomer | C4 | C4 | C4 | C4 | C4 | C4 | C4 | C4 | C4 |
| Density (g/cc) | 0.916 | 0.916 | 0.865 | 0.876 | 0.906 | 0.921 | 0.912 | 0.918 | 0.918 |
| MI (dg/min) | 0.3 | 0.3 | 5.0 | 3.5 | 420 | 16 | 0.6 | 1.0 | 3.0 |
| MIR | 95 | 30 | 34 | 25 | — | 31 | 78 | 25 | 25 |
| Mn (g/mol) | 26,265 | 52.800 | 29,000 | 34,000 | 10,800 | 14,031 | 24,411 | 30,506 | 22,948 |
| Mw (g/mol) | 124,755 | 123,300 | 74,200 | 77,600 | 24,100 | 48,662 | 97,216 | 124,129 | 89,365 |
| Mz (g/mol) | 615,534 | 219,100 | 165,800 | 141,000 | 45,300 | 158,981 | 425,223 | 458,546 | 296,294 |
| Mw/Mn | 4.7 | 4.9 | 2.6 | 2.3 | 2.2 | 3.5 | 4.0 | 4.1 | 3.9 |
| Mz/Mw | 2.3 | 1.8 | 2.2 | 1.8 | 1.9 | 3.3 | 4.4 | 3.7 | 3.3 |
| Mz/Mn | 23.4 | 4.1 | 5.7 | 4.1 | 4.2 | 11.3 | 17.4 | 15.0 | 12.9 |
| Comonomer | 6.000 | 6.100 | 29.341 | 23.215 | 9.908 | 6.780 | 6.820 | 7.200 | 7.600 |
| (wt %) | | | | | | | | | |
| LCB | NA | NA | NA | NA | NA | 1.00 | 1.04 | — | — |
| g′-Mz | | | | | | | | | |
| LCB | NA | NA | NA | NA | NA | 1.00 | 0.99 | — | — |
| g′-Mz + 1 | | | | | | | | | |
| Slope 25 | 2.25 | 0.54 | 2.06 | 1.02 | 1.43 | 3.89 | 1.78 | 0.62 | 0.62 |
| Slope 50 | 3.32 | 0.35 | 3.33 | 1.73 | 1.72 | 3.45 | 3.02 | 0.76 | 0.76 |
| Slope 75 | 2.70 | 0.22 | 8.03 | 3.70 | 2.46 | 3.15 | 3.58 | 1.99 | 1.99 |
| Slope 90 | 1.52 | 0.17 | 12.49 | 5.49 | 3.12 | 3.04 | 3.59 | 3.25 | 3.25 |
| SDBI (° C.) | 23.5 | 6.9 | — | 9.5 | — | 27.1 | 20.4 | 24.5 | 25.4 |
| (Slope 50 + | 3.0 | 0.3 | 5.7 | 2.7 | 2.1 | 3.3 | 3.3 | 1.4 | 1.4 |
| Slope75)/2 | | | | | | | | | |

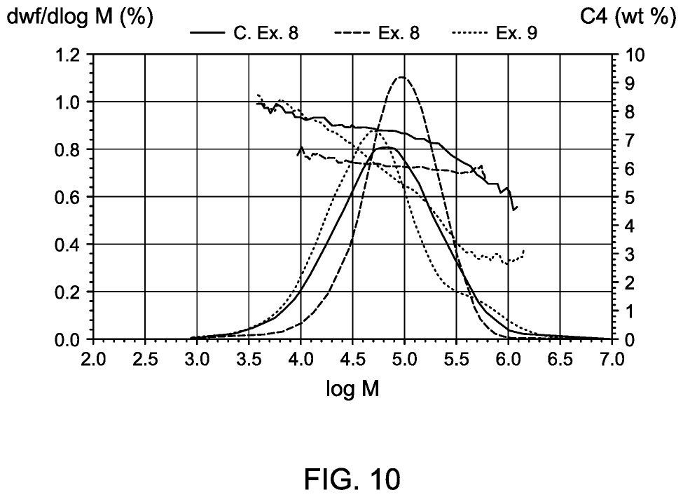

FIG. 10 depicts graphs of the molecular weight distribution and comonomer distribution curves of the samples of Ex.8-9 and C.Ex.8. As exhibited by the curves of the inventive sample of Ex. 8, a broader MWD and a broader comonomer distribution as indicated by a negative slope, could be generated using reactor controls. In contrast, the sample of Ex.9 exhibited a more uniform comonomer distribution as indicated by very little slope.

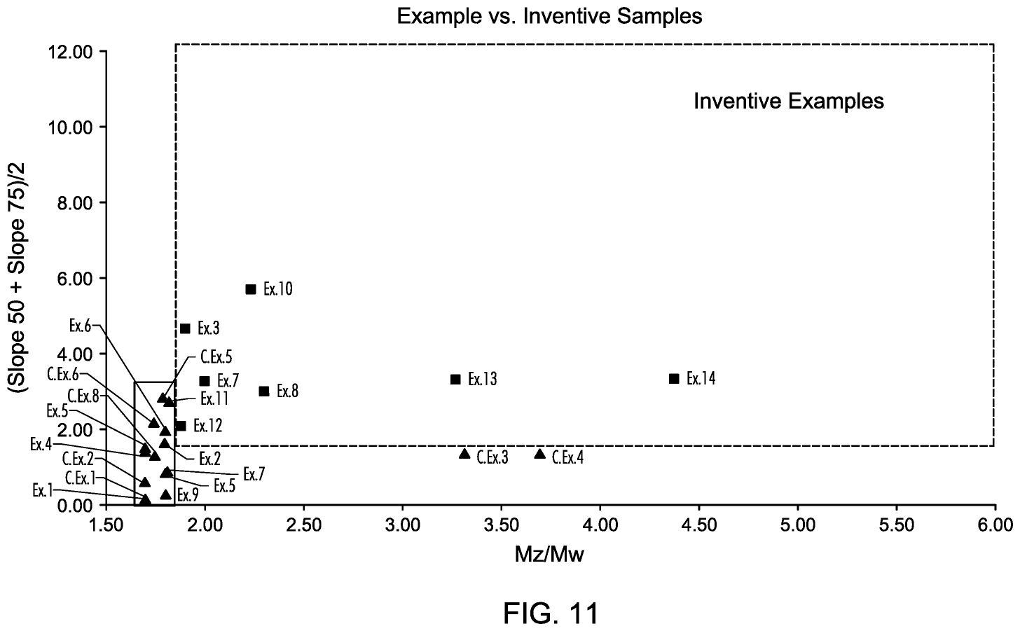

FIG. 11 depicts plots of the averages of slope 50 and slope 75 versus the Mz/Mw values for the samples of Ex. 1-14 and C.Ex.1-8. The averages of the absolute slopes, i.e., (Slope 50+Slope 75)/2, were in the range of 0.1 to 12.0 for all Mz/Mw values in the range of 1.5 to 6.0. Surprisingly, as indicated by the large rectangle shown in FIG. 11, the samples of Exs. 3, 7, 8, 10, 12, 13, and 14 exhibited better absolute slope averages and Mz/Mw values than the samples of C.Ex.1-8 and all other examples, which lie within the smaller rectangle of FIG. 11. These preferred samples of Exs. 3, 7, 8, 10, 12, 13, and 14 had absolute slope averages of about 1.5 to 12.0 and Mz/Mw values of about 1.8 to about 6.0.

### Test Procedures

In all of the foregoing Examples, the densities were measured according to ASTM D792, and the MI values and MIR values (MI_{21.6}/MI_{2.16}) were measured according to ASTM D1238 (190° C./2.16 kg).

The distribution and the moments of molecular weight (Mw, Mn, Mz, Mw/Mn, Mz/Mn, etc.), the comonomer content (C8), and the long chain branching indices (g′) were determined by using a high temperature Gel Permeation Chromatography (Polymer Char GPC-IR) equipped with a multiple-channel band-filter based Infrared detector IR5, an 18-angle light scattering detector and a viscometer. Three Agilent Plgel 10 μm Mixed-B LS columns are used to provide polymer separation. Detailed analytical principles and methods for molecular weight determinations are described in paragraphs [0044]-[0051] of International Publication No. WO/2019/246069A1, which is herein incorporated herein by reference (noting that the equation for c referenced in Paragraph [0044] therein for concentration I at each point in the chromatogram, is c=βI, where β is mass constant and I is the baseline-subtracted IR5 broadband signal intensity (I)). Unless specifically mentioned, all the molecular weight moments used or mentioned in the present disclosure are determined according to the conventional molecular weight (IR molecular weight) determination methods (e.g., as referenced in Paragraphs [0044]-[0045] of the just-noted publication), noting that for the equation in such Paragraph [0044], a=0.695 and K=0.000579(1-0.75 Wt) are used, where Wt is the weight fraction for hexane comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph [0045] of the just-noted International Publication).

The TREF technique was performed as described in Wild, et al., J. Poly. Sci., Poly. Phys. Ed., Vol. 20, pg. 441 (1982) and U.S. Pat. No. 5,008,204, which are incorporated by reference herein.

SDBI measures the breadth of a solubility distribution curve for a given polymer. The procedure used herein for calculating SDBI is described in International Publication No. WO 93/03093 (pages 16 to 18), which is incorporated by reference herein.

### Listing of Embodiments

This disclosure may further include any one or more of the following non-limiting embodiments:

1. A process for making an olefin copolymer, comprising: introducing an olefin monomer, at least one other olefin comonomer, and a single type of catalyst system to a tubular reactor to produce an olefin copolymer comprising: a) an absolute comonomer distribution (CD) slope 90 of about 2.0 to about 30.0, an absolute CD slope 75 of about 2.0 to about 30.0, an absolute CD slope 50 of about 2.0 to about 30.0, or an absolute CD slope 25 of about 2.0 to about 30.0; b) a first long chain branching index (g′(Mz)) of about 0.30 to about 1.0; and c) a second long chain branching index (g′(Mz+1)) of about 0.30 to about 1.0.

2. The process of embodiment 1, wherein an absolute average of CD slope 50 and CD slope 75, an absolute average of CD slope 25 and CD slope 50, or an absolute average of CD slope 75 and CD slope 90 is about 1.5 to about 12.0 when Mz/Mw is about 1.8 to 6.0.

3. The process of embodiment 1 or 2, wherein the tubular reactor comprises a recycle pump.

4. The process of embodiments 1 to 2, wherein the tubular reactor comprises a spiral heat exchanger.

5. The process of embodiments 1 to 4, wherein the catalyst system includes a metallocene catalyst comprising a Group 4 organometallic compound comprising two ancillary monanionic ligands, each of which is independently substituted or unsubstituted, wherein the ligands are bonded by a covalent bridge comprising a substituted single Group 14 atom, the substitution on said Group 14 atom comprising aryl groups, at least one of which comprises at least one hydrocarbylsilyl substituent group.

6. The process of embodiment 5, wherein the hydrocarbylsilyl substituent has the formula Rₙ″SiR′₃₋ₙ, wherein each R′ is independently a C₁-C₂₀ hydrocarbyl, hydrocarbylsilyl, hydrofluorocarbyl substituent, R″ is a Cₜ-C₁₀ linking group between Si and the aryl group, and n=0 or 1.

7. The process of embodiments 1 to 6, wherein the olefin monomer and the at least one other olefin comonomer are copolymerized using a continuous solution polymerization process.

8. The process of embodiments 1 to 7, further comprising introducing hydrogen to the reactor, wherein the olefin monomer is ethylene, and wherein the at least one other olefin comonomer comprises at least one C4 to C20 olefin.

9. The process of embodiment 8, further comprising: calculating a weight average molecular weight (Mw) of the olefin copolymer using the following equation: (Mw)^{2.2}=−2.1E+011+1.5E+9*T avg−2.7E+8*H2/C2+4.1E+10*C2 conc+3.4E+011*C8 conc−1.8E+9*T avg*C8 conc−1.9E+010*C2 conc*C8 conc, wherein T_{avg} is average reactor temperature, H2/C2 is a molar ratio of the hydrogen to the ethylene introduced to the reactor, C2 conc is the ethylene concentration in wt %, and C8 conc is the at least one other comonomer concentration in wt %, all weight percentages being based on the total weight of the solution introduced to the reactor; and controlling the Mw based on the calculated Mw.

10. The process of embodiment 8, further comprising: calculating the CD slope 90 using the following equation: Sqrt(Slope 90)=+0.11−7.6E-003*H2/C2+0.5*C2 conc−0.2*C8 conc+0.20*Cement conc, wherein T_{avg} is average reactor temperature, H2/C2 is a molar ratio of the hydrogen to the ethylene introduced to the reactor, C2 conc is the ethylene concentration in wt %, C8 conc is the at least one other comonomer concentration in wt %, and Cement conc is cement concentration in wt %, all weight percentages being based on the total weight of the solution introduced to the reactor; and controlling the comonomer distribution based on the calculated CD slope 90.

11. The process of embodiment 8, further comprising: calculating the CD slope 75 using the following equation: Sqrt(Slope 75)=+2.6-0.011*T avg−5.7E-003*H2/C2+0.13*C2 conc−0.06*C8 conc+0.10*Cement Conc, wherein T_{avg} is average reactor temperature, H2/C2 is a molar ratio of the hydrogen to the ethylene introduced to the reactor, C2 conc is the ethylene concentration in wt %, C8 conc is the at least one other comonomer concentration in wt %, and Cement conc is cement concentration in wt %, all weight percentages being based on the total weight of the solution introduced to the reactor; and controlling the comonomer distribution based on the calculated CD slope 75.

12. The process of embodiment 8, further comprising: calculating the first long chain branching index using the following equation: g′-Mz=+0.89+1.47E-004*H2/C2+0.02*C2 conc−2.8E-003*C8 conc−2.8E-005*PRPM, wherein H2/C2 is a molar ratio of the hydrogen to the ethylene introduced to the reactor, C2 conc is the ethylene concentration in wt,%, C8 conc is the at least one other comonomer concentration in wt %, and PRPM is the pump speed in the reactor, all weight percentages being based on the total weight of the solution introduced to the reactor; and controlling the first long chain branching index based on the calculated first long chain branching index.

13. The process of embodiment 3, wherein the olefin copolymer is produced at a cement concentration of about 2 wt % and to about 40 wt % and at a recycle ratio of about 3 to about 50.

14. The process of embodiments 1 to 13, wherein the olefin copolymer has a MWD of about 2.0 to about 7.0.

15. The process of embodiments 1 to 14, wherein the olefin copolymer has a melt index of about 0.1 dg/min to about 500.0 dg/min, as measured according to ASTM D1238 (190° C./2.16 kg).

16. The process of embodiments 1 to 15, wherein the olefin copolymer has a melt index ratio (MI_{21.6}/MI_{2.16}) of about 20.0 to about 100.0, as measured according to ASTM D1238.

17. The process of embodiments 1 to 16, wherein the olefin copolymer has a density of about 0.850 g/cc to about 0.920 g/cc, as measured according to ASTM D792.

18. The process of embodiments 1 to 17, wherein the first long chain branching index is about 0.70 to about 0.97, and wherein the second long chain branching index is about 0.70 to about 0.97.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A process for making an olefin copolymer, comprising:
introducing an olefin monomer, at least one other olefin comonomer, and a single type of catalyst system to a tubular reactor to produce an olefin copolymer comprising:
a) an absolute comonomer distribution (CD) slope 90 of about 2.0 to about 30.0, an absolute CD slope 75 of about 2.0 to about 30.0, an absolute CD slope 50 of about 2.0 to about 30.0, or an absolute CD slope 25 of about 2.0 to about 30.0;
b) a first long chain branching index (g′(Mz)) of about 0.30 to about 1.0; and
c) a second long chain branching index (g′(Mz+1)) of about 0.30 to about 1.0.

2. The process of claim 1, wherein an absolute average of CD slope 50 and CD slope 75, an absolute average of CD slope 25 and CD slope 50, or an absolute average of CD slope 75 and CD slope 90 is about 1.5 to about 12.0 when MZ/MW is about 1.8 to 6.0.

3. The process of claim 1, wherein the tubular reactor comprises a recycle pump.

4. The process of claim 1, wherein the tubular reactor comprises a spiral heat exchanger.

5. The process of claim 1, wherein the catalyst system includes a metallocene catalyst comprising a Group 4 organometallic compound comprising two ancillary monanionic ligands, each of which is independently substituted or unsubstituted, wherein the ligands are bonded by a covalent bridge comprising a substituted single Group 14 atom, the substitution on said Group 14 atom comprising aryl groups, at least one of which comprises at least one hydrocarbylsilyl substituent group.

6. The process of claim 5, wherein the hydrocarbylsilyl substituent has the formula Rn″SiR′3-n, wherein each R′ is independently a Cₜ-C20 hydrocarbyl, hydrocarbylsilyl, hydrofluorocarbyl substituent, R″ is a Cₜ-C10 linking group between Si and the aryl group, and n=0 or 1.

7. The process of claim 1, wherein the olefin monomer and the at least one other olefin comonomer are copolymerized using a continuous solution polymerization process.

8. The process of claim 1, further comprising introducing hydrogen to the reactor, wherein the olefin monomer is ethylene, and wherein the at least one other olefin comonomer comprises at least one C4 to C20 olefin.

9. The process of claim 8, further comprising: calculating a weight average molecular weight (Mw) of the olefin copolymer using the following equation: (Mw)2.2=−2.1E+011+1.5E+9*T avg−2.7E+8*H2/C2+4.1E+10*C2 conc+3.4E+011*C8 conc−1.8E+9*T avg*C8 conc−1.9E+010*C2 conc*C8 conc, wherein Tavg is average reactor temperature, H2/C2 is a molar ratio of the hydrogen to the ethylene introduced to the reactor, C2 conc is the ethylene concentration in wt %, and C8 conc is the at least one other comonomer concentration in wt %, all weight percentages being based on the total weight of the solution introduced to the reactor; and controlling the Mw based on the calculated Mw.

10. The process of claim 8, further comprising: calculating the CD slope 90 using the following equation: Sqrt(Slope 90)=+0.11−7.6E-003*H2/C2+0.5*C2 conc−0.2*C8 conc+0.20*Cement conc, wherein Tavg is average reactor temperature, H2/C2 is a molar ratio of the hydrogen to the ethylene introduced to the reactor, C2 conc is the ethylene concentration in wt %, C8 conc is the at least one other comonomer concentration in wt %, and Cement conc is cement concentration in wt %, all weight percentages being based on the total weight of the solution introduced to the reactor; and controlling the comonomer distribution based on the calculated CD slope 90.

11. The process of claim 8, further comprising: calculating the CD slope 75 using the following equation: Sqrt(Slope 75)=+2.6-0.011*T avg−5.7E-003*H2/C2+0.13*C2 conc−0.06*C8 conc+0.10*Cement Conc, wherein Tavg is average reactor temperature, H2/C2 is a molar ratio of the hydrogen to the ethylene introduced to the reactor, C2 conc is the ethylene concentration in wt %, C8 conc is the at least one other comonomer concentration in wt %, and Cement conc is cement concentration in wt %, all weight percentages being based on the total weight of the solution introduced to the reactor; and controlling the comonomer distribution based on the calculated CD slope 75.

12. The process of claim 8, further comprising: calculating the first long chain branching index using the following equation: g′-Mz=+0.89+1.47E-004*H2/C2+0.02*C2 conc−2.8E-003*C8 conc−2.8E-005*PRPM, wherein H2/C2 is a molar ratio of the hydrogen to the ethylene introduced to the reactor, C2 conc is the ethylene concentration in wt,%, C8 conc is the at least one other comonomer concentration in wt %, and PRPM is the pump speed in the reactor, all weight percentages being based on the total weight of the solution introduced to the reactor; and controlling the first long chain branching index based on the calculated first long chain branching index.

13. The process of claim 3, wherein the olefin copolymer is produced at a cement concentration of about 2 wt % and to about 40 wt % and at a recycle ratio of about 3 to about 50.

14. The process of claim 1, wherein the olefin copolymer has a MWD of about 2.0 to about 7.0.

15. The process of claim 1, wherein the olefin copolymer has a melt index of about 0.1 dg/min to about 500.0 dg/min, as measured according to ASTM D1238 (190° C./2.16 kg).

16. The process of claim 1, wherein the olefin copolymer has a melt index ratio (MI21.6/MI2.16) of about 20.0 to about 100.0, as measured according to ASTM D1238.

17. The process of claim 1, wherein the olefin copolymer has a density of about 0.850 g/cc to about 0.920 g/cc, as measured according to ASTM D792.

18. The process of claim 1, wherein the first long chain branching index is about 0.70 to about 0.97, and wherein the second long chain branching index is about 0.70 to about 0.97.
